(19) United States
(12) Patent Application Publication
(10) Pub. No.: US 2023/0263312 A1
(43) Pub. Date: Aug. 24, 2023

(54) CUSTOMISABLE RESILIENT UNIT AND METHOD OF MANUFACTURE

(71) Applicant: HS PRODUCTS LTD, Leeds West Yorkshire (GB)

(72) Inventors: David Clare, Leeds West Yorkshire (GB); Simon Spinks, Leeds West Yorkshire (GB)

(21) Appl. No.: 18/041,006

(22) PCT Filed: Aug. 18, 2021
(86) PCT No.: PCT/GB2021/052137

§ 371 Date: Feb. 8, 2023

(30) Foreign Application Priority Data
Aug. 19, 2020 (GB) 2012947.4

(51) Int. Cl. A47C 27/06; B68G 7/00

(52) U.S. Cl. CPC A47C 27/064; A47C 27/062; B68G 7/00

(57) ABSTRACT

A pocketed resilient unit (130), such as for a mattress core, comprises integral pocketed resilient elements (110) arranged in clusters (240), wherein each integral pocketed resilient element in a cluster is attached to at least one other integral pocketed resilient element, and wherein the clusters define interstices (250), in at least some of which are located independent resilient elements (260).

The present invention relates to a resilient unit, such as may be used in a mattress, and more particularly to one that may be customised.

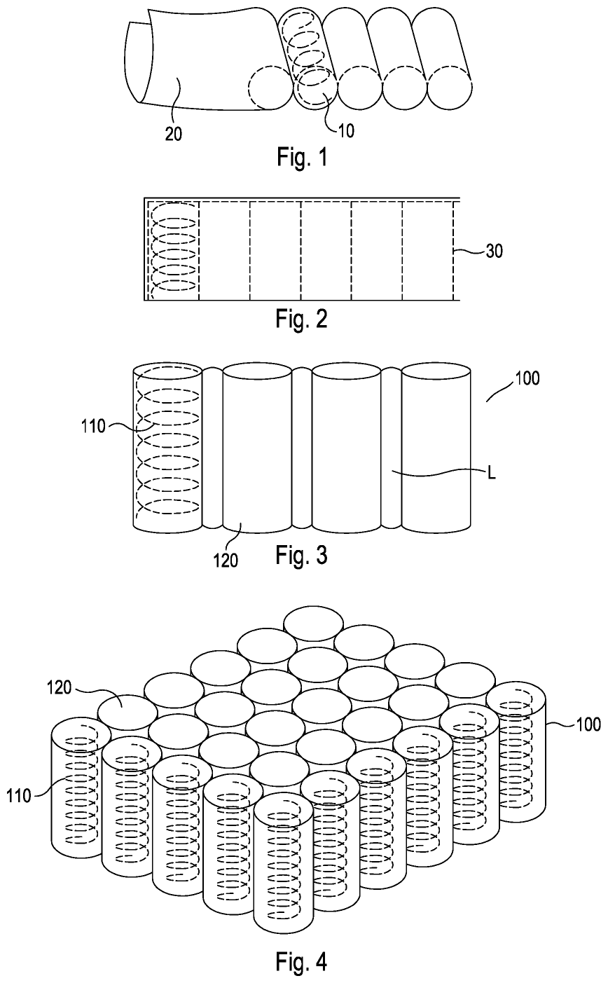

Mattress cores are typically formed from coil springs encased in pockets. Referring to FIG. 1, the springs 10 are initially placed between sheets or plies of pocketing material, which could be a single sheet 20 folded into two. The sheets are then glued, stitched or welded along their edges and between the springs to encase the springs in individual pockets. FIGS. 2 and 3 are respective schematic side and perspective views of a so-called “string” 30 of springs formed in this way.

The strings 30 are then glued together along the cylindrical surfaces of the pocketed springs to form an array 40 as shown in FIG. 4. Such an array, of an appropriate length and width, is used as a mattress core.

Glue is expensive and cannot easily be recycled, so in recent times efforts have been made to find alternative means of holding the strings together. However, thus far, many such alternatives have either proved inflexible or expensive to manufacture or both.

Furthermore, it may be desirable to be able to create variations in the appearance or resilient characteristics of a mattress readily during its manufacture.

Embodiments of the present invention aim to provide a resilient unit suitable for a mattress, which unit may have at least one characteristic changed, or customised, whilst using little or no glue, thereby allowing it to be readily recycled.

The present invention is defined in the attached independent claims, to which reference should now be made. Further, preferred features may be found in the sub-claims appended thereto.

According to one aspect of the present invention, there is provided a pocketed resilient unit comprising integral pocketed resilient elements arranged in clusters, wherein each integral pocketed resilient element in a cluster is attached to at least one other integral pocketed resilient element, and wherein the clusters define spaces or interstices, in at least some of which are located independent resilient elements.

Preferably the resilient unit comprises a plurality of strings of integral pocketed resilient elements each of which is linked to at least one other integral pocketed resilient element in the same string by a common web of pocketing material.

Each string is preferably joined to at least one other string.

The integral pocketed resilient elements preferably comprise a resilient element encased in an individual pocket. The string preferably comprises a plurality of integral pocketed resilient elements arranged with substantially parallel axes.

The resilient elements may comprise springs and more preferably may comprise coil springs, for example of metal, such as steel.

The independent resilient elements may be unconnected to other resilient elements. In a preferred arrangement, the independent resilient elements do not form part of a string.

The independent resilient elements preferably do not share a web of pocketing material with an integral resilient element.

The independent resilient elements may be pocketed or un-pocketed. The resilient unit may include a combination of pocketed and un-pocketed independent resilient elements.

The independent resilient elements may differ from the integral resilient elements in respect of at least one characteristic, such as one or more of, but not limited to: length, width, stiffness, colour and material composition. The resilient unit may include one or more independent resilient elements having characteristics that differ from at least one other independent resilient element in the resilient unit according to one or more characteristics including but not limited to: length, width, stiffness, colour and material composition.

The independent resilient elements may be arranged to create zones in the resilient unit having different characteristics.

The resilient unit may comprise a resilient core for an upholstered article such as a mattress.

The invention includes a mattress including a resilient unit according to any statement herein.

According to another aspect of the present invention, there is provided a method of making a resilient unit comprising arranging integral pocketed spring elements in clusters, wherein each integral pocketed resilient element in a cluster is attached to at least one other integral resilient element, and wherein the clusters define spaces or interstices, and inserting an independent resilient element into one or more of the spaces or interstices.

Preferably the independent resilient element is inserted into the interstice using an inserter mechanism, which may comprise an inserter tube. The inserter mechanism may comprise a funnel.

The method may include introducing the inserter mechanism at least partly into the interstice, placing the independent resilient element into the inserter mechanism and withdrawing the inserter mechanism leaving the independent resilient element at least partly located within the interstice.

The independent resilient element may be introduced into the interstice using a pusher, which may comprise a piston. Alternatively, or in addition, the independent resilient element may be inserted into the interstice by fluid pressure, for example by blowing.

Alternatively, or additionally, the method may comprise placing the independent resilient element adjacent to at least one member of a partially formed cluster and enclosing the independent resilient element in an interstice, for example by joining one or more further integral resilient elements to the resilient unit.

The invention may include any combination of the features or limitations referred to herein, except such a combination of features as are mutually exclusive, or mutually inconsistent.

A preferred embodiment of the present invention will now be described, by way of example only, with reference to the accompanying diagrammatic drawings, in which:

FIGS. 1-3 show some pocketed springs in a string, at different stages of manufacture, according to a previously considered structure;

FIG. 4 shows in schematic perspective view a plurality of strings joined together to form a resilient core unit according to a previously considered structure;

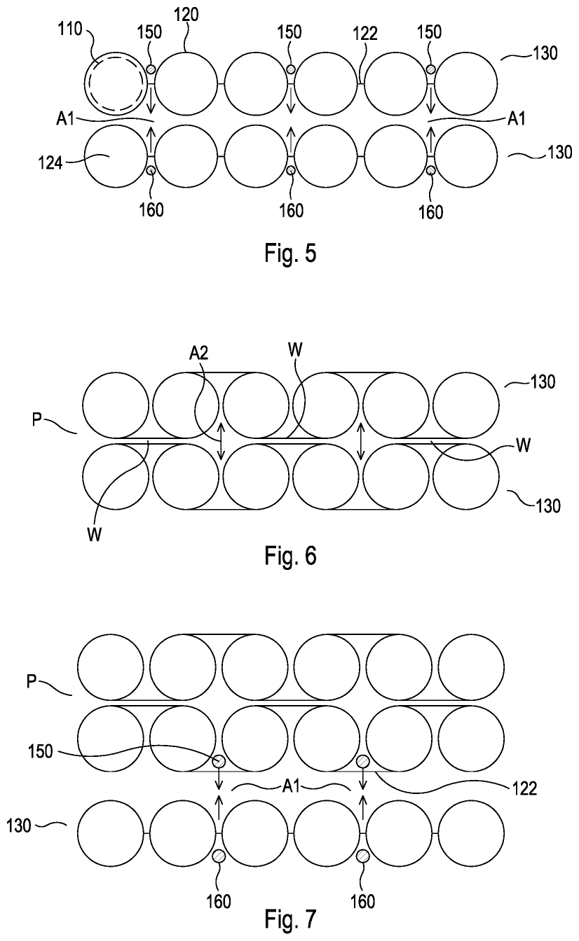

FIG. 5 shows, in schematic plan view, two strings of pocketed springs in an early stage of manufacture of a resilient core unit according to an embodiment of the present invention;

FIGS. 6 and 7 show schematically further method steps for producing the resilient core unit of FIG. 5;

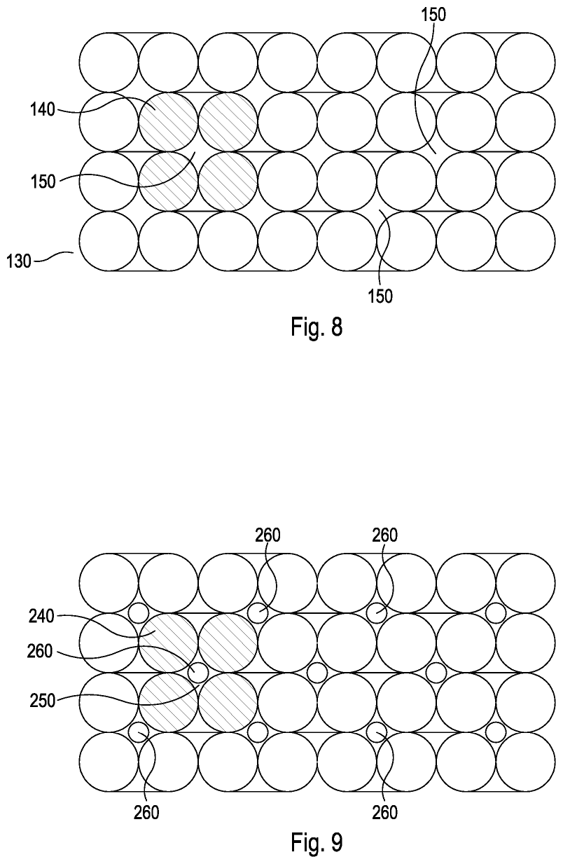

FIGS. 8 and 9 are schematic plan views of the resilient core unit of FIGS. 5-7 further, later stages of manufacture; and

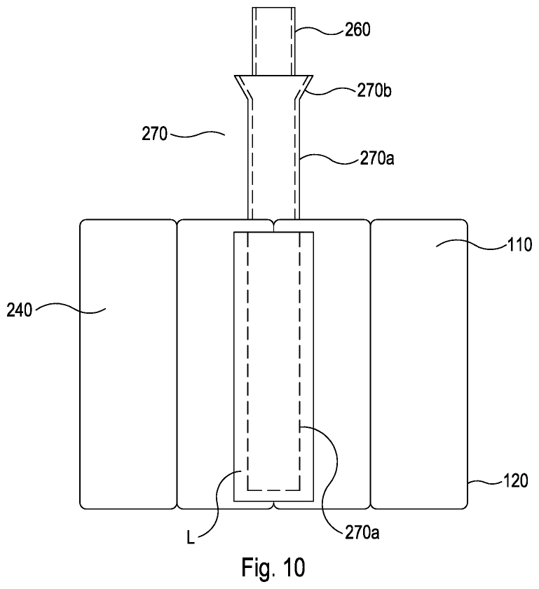

FIG. 10 shows schematically an apparatus for making the resilient unit of FIGS. 5-9 at a later stage of manufacture.

Turning to FIG. 5, this shows two single strings 130 of pocketed springs, each comprising a linear array of metal, e.g. steel, coil springs 110 encased in individual pockets formed by sheets 120 of weldable pocketing material, which may, for example, comprise spun-bonded polymer, e.g. polyester or polypropylene. It should be noted that the strings shown as examples contain only six individual pocketed springs, whereas in reality they would include more than this, depending upon the desired dimensions of the resilient core unit being manufactured.

The sheets 120 (which may comprise a single sheet that has been folded over the springs or may comprise two separate sheets) are joined along their edges (not shown), in this example by ultrasonic welds. The sheets are also joined between the springs 110, again in this example by ultrasonic welds, to form connection portions 122, thereby defining individual pockets 124 for the springs 110. The connection portions are parts of the sheets, or plies, that have been joined between the springs, in the formation of the pockets. The two strings are aligned in parallel before the next step of the method in which sets of ultrasonic welding tools, comprising sonotrodes (or horns) 150 and anvils 160 are brought together to weld alternate ones of the connection portions 122 together in the direction of Arrows A1, thereby joining the strings 130.

FIG. 6 shows the two strings after the welding operation. Where the welding has taken place, the connection portions 122 of the two strings 130 are joined by ultrasonic welds W. The welds W are located between the strings 130 and effectively bring four pockets 124 together. The welding tools 150 and 160 have pushed together and joined the connecting portions 122 of alternate pairs of pocketed springs. In doing so the pockets either side of the weld W have been rotated somewhat, so that the unwelded connecting portions have become pushed outwards in the direction of Arrows A2 and are now present on the outward facing sides of the pair P of strings.

FIG. 7 shows the next step, in which a new string 130 is placed alongside the joined pair P. The position of the welding tools has been shifted laterally along the strings 130 by a distance of one spring so that the unwelded connecting portions 122 of the pair P are aligned for welding with corresponding connecting portions 122 of new string 130. Once again, the sets of welding tools 150, 160 are brought together and the new string 130 is joined to the pair P. The result, a partly formed pocketed spring unit 140, is shown in FIG. 8.

The process is repeated, each time indexing the unit 140 and moving the welding tools back and forth, in a reciprocal manner, so as to weld alternate connecting portions to the new string until a sufficient number of strings, or rows, have been added.

The joining of the strings takes place on a supporting surface which may include apparatus (not shown) for gripping and moving the individual strings 130, and/or for indexing the unit 140. Both sets of welding tools 150 and 160 may be inserted beside the connecting portions 122 from above and/or below the unit, i.e. in a direction parallel with the axes of the springs themselves, or else at least one of the sets of welding tools, for example 160, may be introduced in a direction substantially transverse to the axes of the springs, for example in the direction in which the new string is being presented, i.e. transverse to the extent of the string. Whereas the tools 150 and 160 are described in this 30 example as, respectively sonotrodes and anvils, their positions/roles could be reversed.

Indeed, the example of ultrasonic welding apparatus could be replaced by thermal bonding, or heat-sealing tools.

FIG. 8 shows the resilient unit 130 in schematic plan from which it can be seen that the joined strings create clusters—or modules—240 of springs (one of which is shown shaded) which define spaces, or interstices, 250 between springs in the clusters.

FIG. 9 shows in schematic plan view a resilient unit 130 at a later stage of manufacture.

Within the interstices 250 are located independent resilient units 260, which in this case are individual pocketed coil springs. The independent springs 260 are not integral with the rest of the resilient unit and do not share pocketing material/web with any of the integral springs 110. Instead, the independent springs have been inserted into the spaces 250 so that their axes are substantially parallel with the integral springs 110.

FIG. 10 shows schematically an apparatus for inserting an independent spring 260 into one of the interstices formed by a spring cluster 240. The independent spring 260 is, in this example, a pocketed coil spring of approximately the same axial length as the springs 110 making up the cluster 240, but of a smaller diameter. In order to insert the independent spring 260, an inserter device 270, of plastics or metal, is placed substantially vertically above the interstice. The device 270 comprises a tube 270a with a frusto-conical funnel portion 270b at its upper end.

To insert the independent spring into the cluster, the device 270 is first inserted into the interstice 250 and then the spring 260 is inserted into the device 270. This can be achieved by blowing the spring 260 as it is a pocketed spring. Alternatively, a pusher device, such as a piston, could be employed and this would be more effective in the case of an un-pocketed independent spring. Once the spring 260 is fully inserted into the interstice, the device 270 can be withdrawn.

Another way of incorporating the independent springs into the interstices formed by the clusters would be to place the independent springs into predetermined interstice locations as the resilient unit is being formed, i.e. as the clusters are being created, for example during the joining of the strings of springs. In this embodiment, the springs are placed beside the previous string of integral springs, before the next string is introduced.

The independent springs may be pocketed or un-pocketed and may have characteristics such as length, diameter, stiffness, material composition or colour that are chosen to bestow particular characteristics on the resilient unit. For example, it may be desirable for certain portions, regions or zones of the resilient unit to be stiffer—or more resilient—than others and this may be achieved by careful selection of the type of independent spring, as well as their number and location.

In the example shown and described herein, the clusters are made up of four resilient elements. However, the clusters could be made up of other numbers of resilient elements.

Whilst endeavouring in the foregoing specification to draw attention to those features of the invention believed to be of particular importance, it should be understood that the applicant claims protection in respect of any patentable feature or combination of features referred to herein, and/or shown in the drawings, whether or not particular emphasis has been placed thereon.

1. A pocketed resilient unit comprising integral pocketed resilient elements arranged in clusters, wherein each integral pocketed resilient element in a cluster is attached to at least one other integral pocketed resilient element, and wherein the clusters define interstices, in at least some of which are located independent resilient elements.

2. A unit according to claim 1, wherein the resilient unit comprises a plurality of strings of integral pocketed resilient elements each of which is linked to at least one other integral pocketed resilient element in the same string by a common web of pocketing material.

3. A unit according to claim 2, wherein each string is joined to at least one other string.

4. A unit according to claim 1, wherein the integral pocketed resilient elements comprise a resilient element encased in an individual pocket.

5. A unit according to claim 1, wherein the resilient elements comprise springs.

6. A unit according to claim 1, wherein the independent resilient elements are unconnected to other resilient elements.

7. A unit according to claim 1, wherein the independent resilient elements differ from the integral resilient elements in respect of at least one characteristic, such as one or more of, but not limited to: length, width, stiffness, colour and material composition.

8. A unit according to claim 1, wherein the resilient unit includes one or more independent resilient elements having characteristics that differ from at least one other independent resilient element in the resilient unit according to one or more characteristics including but not limited to: length, width, stiffness, colour and material composition.

9. A unit according to claim 1, wherein the independent resilient elements are arranged to create zones in the resilient unit having different characteristics.

10. A mattress including a resilient unit according to claim 1.

11. A method of making a resilient unit, the method comprising arranging integral pocketed spring elements in clusters, wherein each integral pocketed resilient element in a cluster is attached to at least one other integral resilient element, and wherein the clusters define interstices, and inserting an independent resilient element into one or more of the interstices.

12. A method according to claim 11, wherein the independent resilient element is inserted into the interstice using an inserter mechanism comprising a tube or funnel.

13. A method according to claim 12, wherein the method includes introducing the inserter mechanism at least partly into the interstice, placing the independent resilient element into the inserter mechanism and withdrawing the inserter mechanism leaving the independent resilient element at least partly located within the interstice.

14. A method according to claim 11, wherein the independent resilient element is introduced into the interstice using a pusher, such as a piston.

15. A method according to claim 11, wherein the independent resilient element is inserted into the interstice by fluid pressure, for example by blowing.

16. A method according to claim 11, wherein the method comprises placing the independent resilient element adjacent to at least one member of a partially formed cluster and enclosing the independent resilient element in an interstice, for example by joining one or more further integral resilient elements to the resilient unit.
